(19) United States
(12) Patent Application Publication
(10) Pub. No.: US 2003/0006093 A1
(43) Pub. Date: Jan. 9, 2003

(54) Safety restraint

(76) Inventor: Robert Nicholas Ferderber, Osteen, FL (US)

Correspondence Address: ROBERT NICHOLAS FERDERBER, 600 River Oaks Dr., Osteer, FL, 32764, US

(21) Appl. No.: 09/900,221

(22) Filed: Jul. 7, 2001

(51) Int. Cl. A62B 1/16

(52) U.S. Cl. 182/3

(57) ABSTRACT

The primary purpose of this device is to prevent an individual from being thrown from and or injured do to loss of balance from his or hers controlled position. The individual is wearing a waist safety belt, around his or her waist; a lanyard is secure to the waist safety belt, on the other end the lanyard, the lanyard is secured to the top of the safety pole; this safety pole is anchored to a section of a watercraft. The safety pole is attached vertical to a platform, whether on a raised platform above the watercraft floor level, or at floor level. The safety pole may be fixed (anchored) to the watercrafts surface or removable, for storage or transportation. When an individual is performing a function on his or her watercraft, where as, the individual loses his or her balance, to a point of eminent danger or loss of control, this safety device when installed properly and worn correctly, will prevent the individual from losing his or her balance and restore the individual to a point of control, where the individual can regain his or her balance.

### BACKGROUND OF THE INVENTION

The present invention is for those fisherman and women who use their watercraft for personnel and or commercial use. When attached properly according to specifications to the watercrafts raised platform or floor level, gives the individual peace of mind and the ability to recover from sudden movement, or loss of balance.

It is a principal object of the present invention to provide the individual when attached securely to the primary safety pole, by means of the use of a lanyard and safety waist belt, the fisherman or women can function normally in performing activities such as; poling, fishing, throwing a cast net and observing the horizon, without fear of bodily harm and being thrown into the water.

Another object is to provide storage for fishing tackle, fishing poles, poling paraphernalia, when the individual is doing other chores. These storage devices may be added to the primary safety pole as extras, these are considered custom request of the individual. The primary materials of this safety device will be; the primary safety pole, the base plate and hardware (anchor bolts, and safety pin).

### SUMMARY OF THE INVENTION

In accordance with the foregoing objects, the invention the safety device is a metal pole and anchor plate; the pole and plate should be of the same metals in nature. The top of the safety pole is welded appendages, protruding on opposite sides of the primary safety pole, at 90-degree angles. These appendages are of the same metal characteristics of the primary safety pole. The outside diameter and thickness is smaller in size than the primary safety pole. The appendages are bent in the shape of the letter U, the radius of the U is six inches, and the radius may change to meet manufactures specifications. The U shape appendages are welded 90 degrees opposite of each other to the top of the primary pole. The appendages may or may not be attached to the primary safety pole. The purpose of the appendages is for lower back support and something to grasp at for stab or the ability to pull ones self up from a lower position to a higher position. At the base of the primary safety pole are (6) predrilled holes 4″ apart-drilled horizontally thru both sides of the primary safety pole. Separate from the primary safety device is a metal plate; this plate will be rectangular in shape. Size and thickness will be determined by manufactures specifications, on the plate at the four corners of the rectangle, offset 1″ from the sides will be predetermined drill holes going thru the plate. The purpose of the holes is to attach the plate with anchor bolts to the watercrafts structure. In the center of the base plate in a prescribed location will be another hole drilled thru the base plate. The diameter of this hole will be larger than the primary safety poles outside diameter. Inside this hole, another hollow pipe will be welded at 90 degrees to the plate; the top of the hollow pipe will be welded flush to the top surface of the base plate. On the underside of the base plate the hollow pipe will be welded around the outside diameter of the pipe to the base plate. The pipe will protrude 8″ below the base plate at a 90-degree angle of the plate. The pipe welded to the base plate will have the same metal characteristics of the plate and primary safety pole. At the base of the pipe welded to the base plate, 4″ from the bottom of the pipe will be another hole drilled horizontally thru the pipe. The diameter of the hole drilled will be the same diameter of the holes drilled horizontally on the primary safety pole. The purpose of the predrilled holes on both the primary safety pole and the base plate hole is; the primary pole will slide inside the base plate piping, when the two holes line-up, a safety pin will lock the two pipes together, thus preventing the pipe from slipping thru and locking them together. With the prearranged holes on the primary safety pole, the height of the primary pole may be adjusted to fit the individual's height. When the primary safety pole is not been used, the primary pole may be removed from the base plate for transportation or storage, simply by removing the safety pin from the apparatus. Another alternative is to weld the primary safety pole to the base plate, this eliminate the adjustment capabilities and ability to remove the primary safety pole for storage and transportation. This also means that one size fits all. Anchor bolts to the watercrafts surface will still mount the base plate, whether on a raised platform or on the watercrafts primary walking surface.

### BRIEF DESCRIPTION OF THE DRAWING

FIG. 1 is a perspective view of the primary safety pole;

FIG. 2 is an elevation view;

FIG. 3 are perspective views of the primary safety pole and base plate attached to a raised platform, this may be attached to the primary floor level as well.

### DETAILED DISCLOSURE

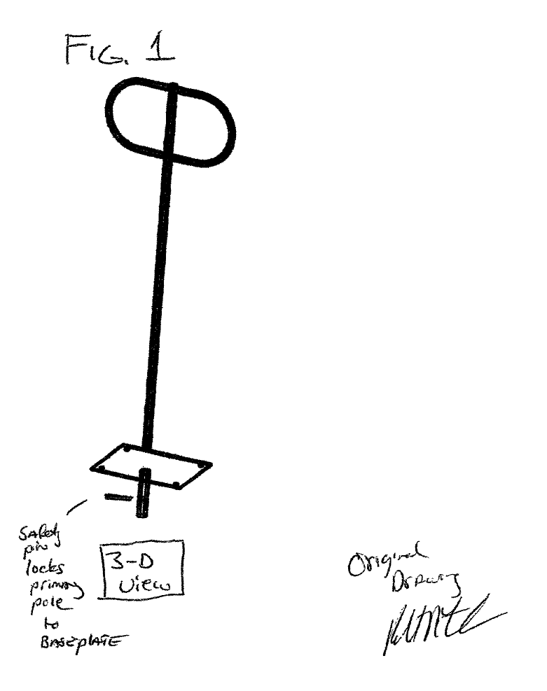

Referring now to the drawing FIG. 1, you will see the appendages attached to the top of the primary safety pole. These appendages may or may not be attached to the primary safety, the purpose of the appendages is for lower back support, when the individual leans against the primary safety pole, and its other purpose is to catch the individual so the individual does not slide from side to side. Another purpose of the appendages is to grab on to when lifting ones self up or using it to lower ones self to a different level of elevation. Another purpose is to catch ones self, incase the individual loses his or her balance. The primary safety pole is separate from the base plate. The base plate is rectangular in shape with an 8″ long pipe with an I.D. larger then the primary safety pole O.D. welded 90 degrees to the base plate. With (4) predrilled holes on the perimeter of the base plate, this base plate will be attached to a raised platform or watercrafts surface by means of anchor bolts. A safety pin will secure the primary safety pole to the base plate; the primary safety pole may be adjustable by moving the primary safety pole up or down the base plate to fit the individuals height. An option; the primary safety pole may be welded to the base plate, thus eliminating the ability to adjust the height of the primary safety pole. One size fits all, the primary safety pole will still be attached to the base plate and the base plate will be attached to the watercraft by anchor bolts. All of the parts of the safety device will be made of the same materials, other than the anchor bolts.

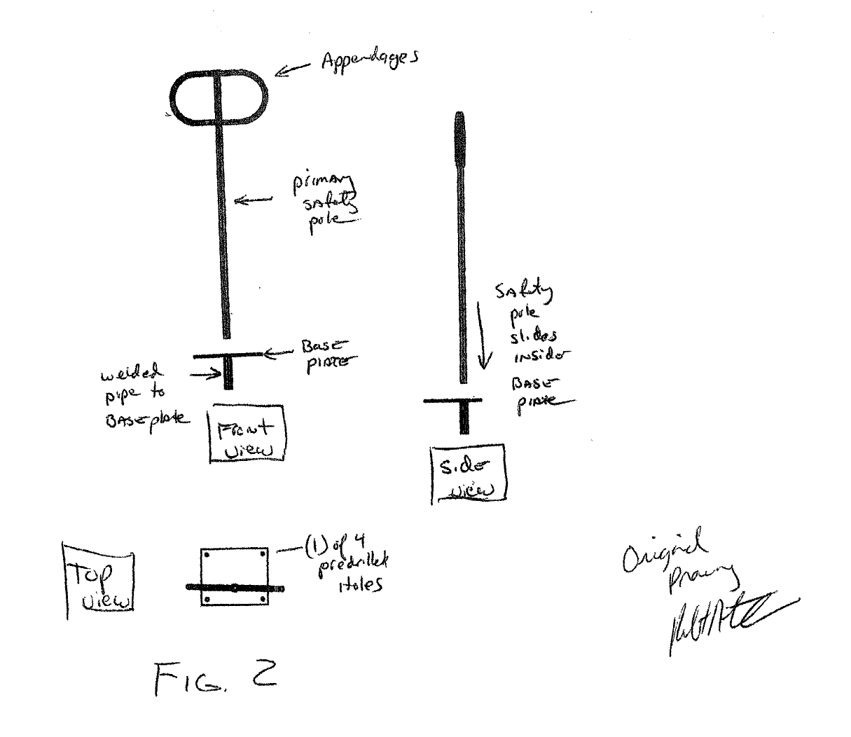

Referring now to the drawing FIG. 2, you will see a front view, side view and top view. On the front view you will see the appendages attached to the top part of the primary safety pole, the diameter of the appendages are smaller then the diameter of the primary safety pole, the diameter is 1″ O.D. of the appendage piping. The appendage has a 6″ radius and the length is 8″ each side. The primary safety pole is 4″-6″ in height is a 3″ O.D. The length and O.D will be determined by the height and weight of the individual. Again a standard length and O.D. may be used. At the base of the primary safety pole, a series of (6) predrilled holes @ ½″ diameter, 4″ apart, drilled horizontally thru both sides is for height adjustment. The base plate is 10″×14″ with a thickness of ¼″. With (4) predrilled holes in each corner of the base plate, offset 1″ from the edges. The diameter of the holes are ½″ drilled thru base plate. In the middle of the base plate another hole 3.5″ in diameter will be drilled thru the base plate. The top of the piping with an O.D. of 3.5″ will be welded flush to the base plate, 90 degrees to the surface. The I.D. of the piping will be 3.25″, thus allowing the primary safety pole with an O.D. of 3″ to slide inside the base plate. The diameter of the piping may vary, with the type of metal stock used. At the base of the piping 4″ from the bottom of the piping on the base plate, will be (1) predrilled hole @ ½″ diameter drilled horizontally thru both sides. The predrilled hole in the base plate piping will match the predrilled holes in the primary safety pole. When the primary safety pole is inserted into the base plate a safety pin will secure the two together. Allowing for adjustment up or down of the primary safety pole to the base plate, depending on the height of the individual. When the safety device is not being used, in storage, or in transportation, the primary safety pole may be removed and stored away. The base plate will remain attached to the watercraft by means of anchor bolts. An alternative, the primary pole may be welded to the base plate thus eliminating the adjustment capabilities, or removal for storage or transportation. The base plate will remain attached to the watercraft by means of anchor bolts.

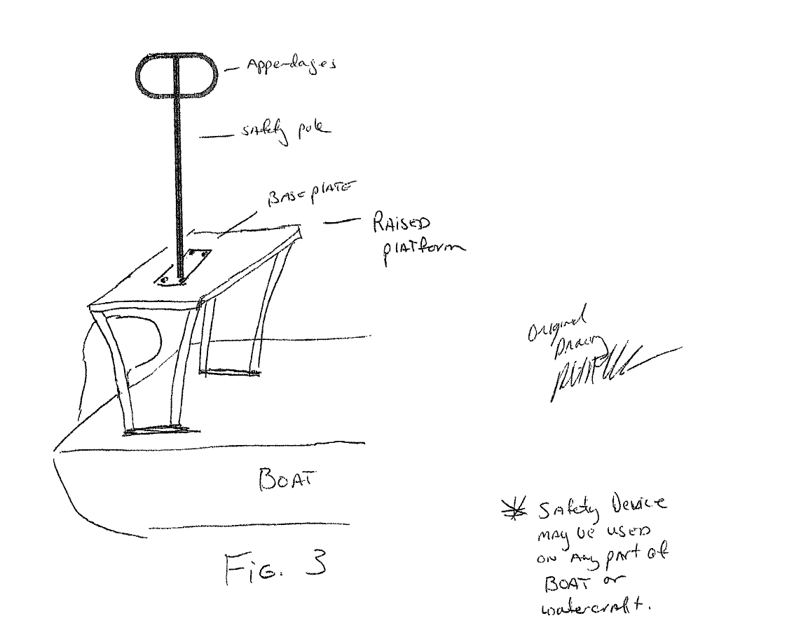

Referring now to the drawing FIG. 3, you will see the primary safety pole and base plate mounted to a raised platform on a watercraft. This device may be attached anywhere on a watercraft. To insure that the primary safety device works properly, a safety lanyard is attached to the primary safety pole. A safety waist belt is attached to the other end of the lanyard. When worn properly, this safety device prevents injury, and lets the individual regain his or her balance, due to an unexpected movement, pitching or stoppage. This safety device may be used without the lanyard or safety waist belt, but no guarantees that the individual will regain stability or sustain from injury. The lanyard and safety belt assist the primary safety device in preventing injury, or loss of control.

From the foregoing, it may be seen that the invention has its advantages to the sportsman or women who use their watercrafts for pleasure or commercially use. This safety device will prevent serious injury, embarrassing moments and the unexpected situations that happen to boaters. When installed properly and worn properly, this safety device prevents injury, and lets the individual regain his or her balance and restore the individual to a point of control, due to an unexpected movement, pitching or stoppage of a watercraft.

Note: The lanyard and safety waist belt may be purchased from other manufactures.

What is claimed is:

1. This safety device is a metal pole and anchor plate; the pole and plate should be of the same metals in nature. Other metals may be used in manufacturing, such as iron, aluminum and or stainless steel. These metals may be finished in primer and paint, anodized, chromed or other metal finishes. The length of the primary safety pole is determined by the height of the individual. The outside diameter and thickness of the primary safety pole is determined by the body weight of the individual.

2. The invention according to claim 1 wherein said at the top of the safety pole are welded appendages, protruding on opposite sides of the primary safety pole, at 90-degree angles. These appendages are of the same metal characteristics of the primary safety pole. The outside diameter and thickness is smaller in size than the primary safety pole. The appendages are bent in the shape of the letter U, the radius of the U is six inches, and the radius may change to meet manufactures specifications. The U shape appendages are welded 90 degrees to the top of the primary pole, giving the impression of a crucifix. The appendages may or may not be attached to the primary safety pole. The purpose of the appendages is for lower back support and something to grasp at for stability, or the ability to pull ones self up from a lower position to a higher position or vise versa, and example is a raised platform on a watercraft, the ability to pull ones self up to a raised platform or lower ones self down from the platform to the watercrafts main floor. The primary safety pole main function with appendages or without is to stabilize the individual from loss of his or her balance.

3. The invention according to claim 2 wherein said at the base of the primary safety pole are (6) vertically predrilled holes 4″ apart-drilled horizontally thru both sides of the primary safety pole. The diameter of the drill holes are to manufactures specifications.

4. The invention according to claim 3 wherein said separate from the primary safety device is a metal plate; this plate will be rectangular in shape, size and thickness to be determined by manufactures specifications. The size may vary to fit the individual's needs, or a standardized size and thickness will apply.

4a. The plate will be made of the same metal characteristics as the primary safety pole.

5. The invention according to claim 4 wherein said on the plate at the four corners of the rectangle, offset 1″ from the sides will be predetermined drill holes going thru the plate. The size will be determined by the manufactures specifications. The purpose of the holes is to attach the plate with anchor bolts to the watercrafts structure or raised platform.

6. The invention according to claim 5 wherein said in the center of the base plate is, or a prescribed location will be another hole drilled thru the base plate. The diameter of this hole will be larger than the primary safety poles outside diameter. Inside this hole of the base plate, another hollow pipe will be welded at 90 degrees to the plate; the top of the hollow pipe will be welded flush to the top surface of the base plate. On the underside of the base plate the hollow pipe will be welded around the outside diameter of the pipe to the base plate. The pipe will protrude 8″ below the base plate at a 90-degree angle of the plate. The pipe welded to the base plate will have the same metal characteristics of the plate and primary safety pole. At the base of the pipe welded to the base plate, 4″ from the bottom of the pipe will be another hole drilled horizontally thru the pipe. The diameter of the hole drilled will be the same diameter of the holes drilled horizontally on the primary safety pole.

6a. The purpose of the predrilled holes on both the primary safety pole and the base plate hole is; the primary pole will slide inside the base plate pipe, when the two holes line-up, a safety pin will lock the two pipes together, thus preventing the pipe from slipping thru and locking them together. With the prearranged holes on the primary safety pole, the height of the primary pole may be adjusted to fit the individual's height.

7. The invention according to claim 6 wherein said when the primary safety pole is not being used, the primary pole may be removed from the base plate for transportation or storage, simply by removing the safety pin from the base plate

8. The invention according to claim 7 wherein said another alternative is to weld the primary safety pole to the base plate, this eliminate the adjustment capabilities and ability to remove the primary safety pole for storage and transportation. This also means that one size fits all. The base plate will still be mounted by anchor bolts to the watercrafts surface, whether a raised platform or on the watercrafts primary walking surface.
